(19) United States
(12) Patent Application Publication
(10) Pub. No.: US 2007/0176847 A1
(43) Pub. Date: Aug. 2, 2007

(54) Method and system to reduce display power consumption

(76) Inventors: Kamalesh R. Shah, Portland, OR (US); Thomas E. Holder, Lake Oswego, OR (US); Jennifer K. Colegrove, Sunnyvale, CA (US); Maximino Vasquez, Fremont, CA (US); Roy Karunakaran, San Jose, CA (US); Yasaman A. Ghazizadeh, Portland, OR (US); Surinder Tuli, Scottsdale, AZ (US); Ralph Mesmer, Banks, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/323,116

(22) Filed: Dec. 30, 2005

(51) Int. Cl. G09G 5/00

(52) U.S. Cl. 345/1.1

(57) ABSTRACT

A method and system to control power consumption of a display system includes using a low power display and a normal power display. The low power display may be a reflective display and may be used when the environment is bright. The normal power display may be a transmissive display and may be used when the environment is not as bright.

### FIELD OF INVENTION

The present invention relates generally to the field of power management, and more specifically, to techniques for reducing power consumption of computer systems.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers. Computer systems typically include one or more processors. A processor may manipulate and control the flow of data in a computer. To provide more powerful computer systems for consumers, processor designers strive to continually increase the operating speed of the processor. As processor speed increases, the power consumed by the processor tends to increase as well. When the power is based on batteries, high power consumption may reduce the battery life.

One approach to reducing overall power consumption of a computer system is to change the focus of power reduction from the processor to other devices that have a significant impact on power. These other devices may include, for example, a display, an input/output (I/O) device, a memory, etc. Studies have shown that the display may consume as much as 30% to 40% of the total platform average power. In order to achieve a continuing goal of extending the battery life, techniques are being developed to reduce the power consumption of the display.

### BRIEF DESCRIPTION OF THE DRAWINGS

The present invention is illustrated by way of example and not limitation in the accompanying figures in which like references indicate similar elements and in which:

FIG. 1 is a block diagram illustrating an example of a computer system.

FIG. 2 illustrates one example of a computer system having dual displays, in accordance with one embodiment.

FIGS. 3A-3B illustrate an example of a display housing, in accordance with one embodiment.

FIGS. 4A-4B illustrate an example of a computer system having dual displays, in accordance with one embodiment.

FIG. 5A-5C illustrate another example of a computer system having dual displays, in accordance with one embodiment.

FIGS. 6A-6B are block diagrams illustrating examples of processes that may be used to reduce power consumption associated with a display system, in accordance with one embodiment.

### DETAILED DESCRIPTION

For some embodiments, a computer system may include a first display and a second display. The first display may be configured to display information in a first environment. The first environment may be generally dark. The second display may be configured to display information in a second environment that is not as dark as the first environment.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Computer System

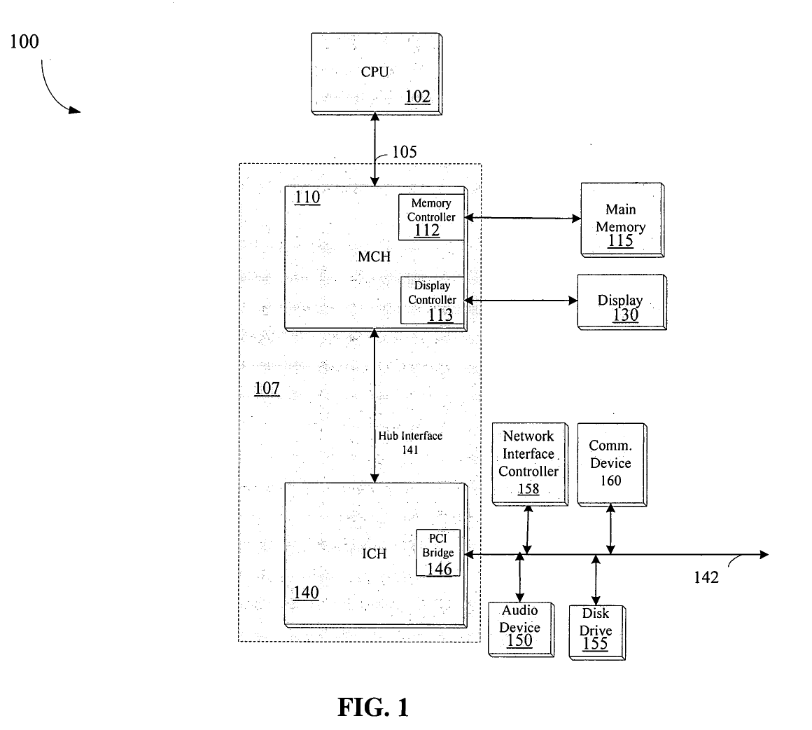

FIG. 1 is a block diagram illustrating an example of a computer system. Computer system 100 may be a portable computer system. Computer system 100 may include a central processing unit (CPU) 102 and may receive its power from an electrical outlet, a battery (not shown), or any other power sources. The CPU 102 and chipset 107 may be coupled to bus 105. The chipset 107 may include a memory control hub (MCH) 110. The MCH 110 may include a memory controller 112 that is coupled to memory 115. The memory 115 may store data and sequences of instructions that are executed by the CPU 102 or any other processing devices included in the computer system 100. The MCH 110 may include a display controller 113. Display 130 may be coupled to the display controller 113. The chipset 107 may also include an input/output control hub (ICH) 140. The ICH 140 may be coupled with the MCH 110 via a hub interface 141. The ICH 140 may provide an interface to peripheral devices within the computer system 100. The ICH 140 may include PCI bridge 146 that provides an interface to PCI bus 142. The PCI bridge 146 may provide a data path between the CPU 102 and the peripheral devices. In this example, an audio device 150, a disk drive 155, communication device 160, and network interface controller 158 may be connected to the PCI bus 142. The disk drive 155 may include a storage media to store data and sequences of instructions that are executed by the CPU 102 or any other processing devices included in the computer system 100.

Transmissive Display

The display 130 may be implemented using transmissive technology and may be referred to herein as a transmissive display 130. Transmissive technology is known to one skilled in the art. Although not shown, the transmissive display 130 may include a backlight, glass substrate, color filters, a liquid crystal (LC) matrix, a light guide, and a light diffuser. Transistors and storage capacitors may be used to control light from the backlight passing through the LC matrix. One advantage of using the transmissive display 130 is its contrast ratio (e.g., 300:1) in dark environment, enabling the information displayed on the transmissive display 130 to be easily readable. One disadvantage of using the transmissive display 130 is the power consumption associated with the backlight. Another disadvantage of using the transmissive display 130 is the low contrast ratio (e.g., 2:1) when being in a bright environment:(e.g., outdoor or near a bright light source). The low contrast ratio may cause the information displayed on the transmissive display 130 hard to read. To correct this situation, a user of the computer system 100 may adjust position of the transmissive display 130. This may include, for example, moving the computer system 100 to a darker environment.

Reflective Display

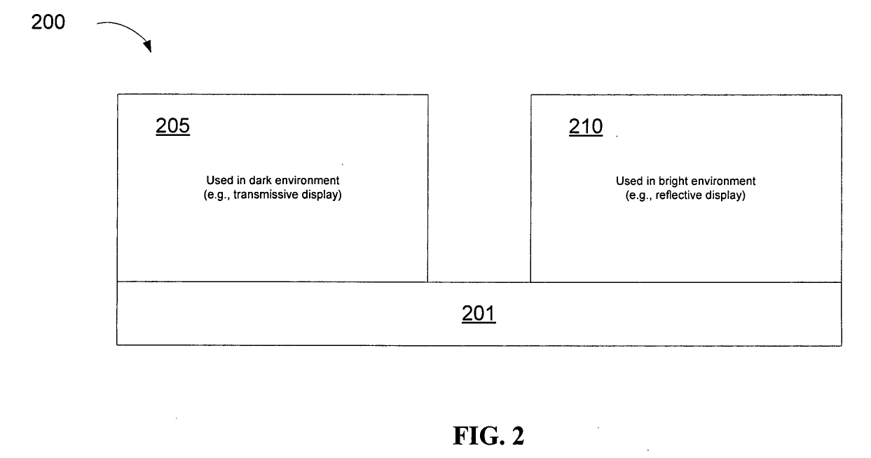

FIG. 2 illustrates one example of a computer system having dual displays, in accordance with one embodiment. Computer system 200 in this example may include two displays 205 and 210. The computer system 200 may also include a base section 201 which may include a processor, memory, a keyboard and other components as described in FIG. 1. For one embodiment, the display 210 may be implemented using reflective technology and may be referred to herein as a reflective display 210. Reflective technology is known to one skilled in the art. The reflective display 210 may rely on external light (e.g., sun light, ambient light, etc.) to enable the information displayed on the reflective display 210 to be readable. One advantage of using the reflective display 210 is its use of the external light instead of the backlight, resulting in lower display power consumption. One disadvantage of using the reflective display 210 is the difficulty of reading the information on a reflective display 210 in a dark environment.

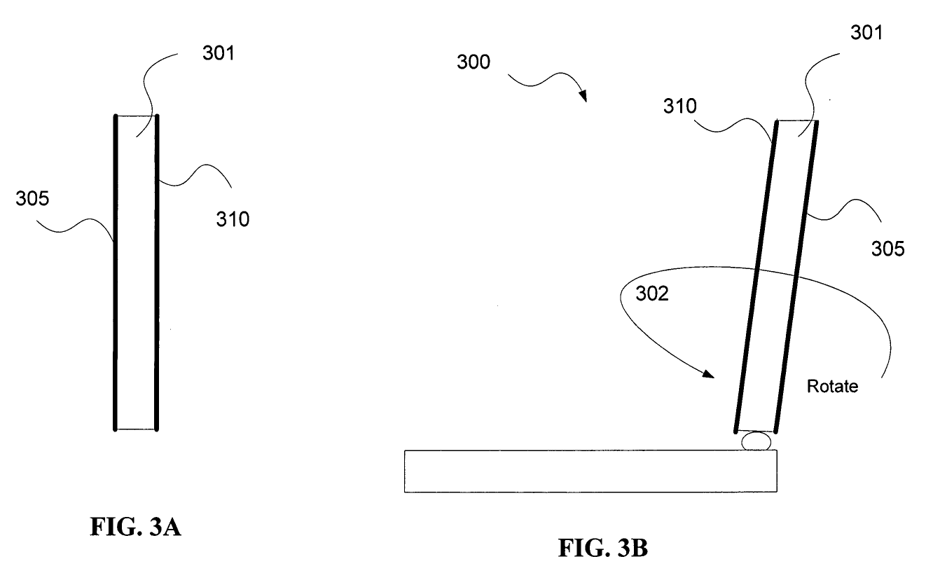

FIG. 3A illustrates an example of a display housing, in accordance with one embodiment. Computer system 300 may include a display housing 301 that may include two displays. One may be a transmissive display 305, and the other may be a reflective display 310. The display housing 301 may include logic associated with the transmissive display 305 and the reflective display 310. The transmissive display 305 and the reflective display 310 may be positioned on each side of the display housing 301 (or opposite from one another), as illustrated in FIG. 3A. For one embodiment, the display housing 301 may be adjusted (shown by the directional arrow 302) to change the position of the two displays, as illustrated in an example in FIG. 3B.

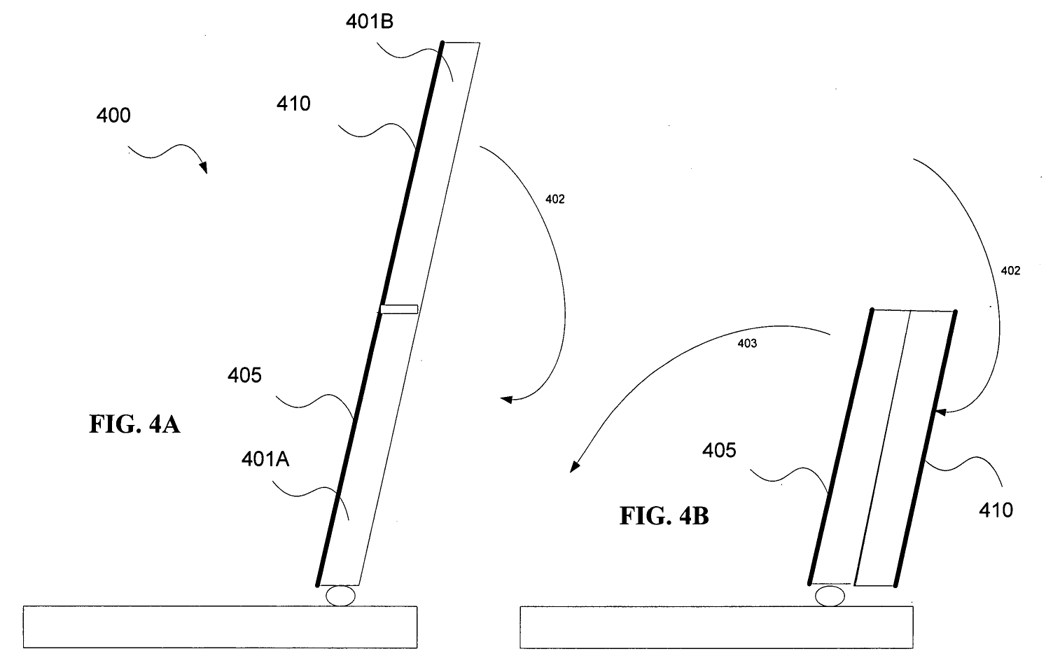

FIG. 4A illustrates an example of a computer system having dual displays, in accordance with one embodiment. For one embodiment, computer system 400 may include a display housing that includes multiple display sections. For example, as illustrated in FIG. 4A, there are two display section 401A and 401B. The two display sections 401A and 401B may be coupled to one another using attachment mechanism (e.g., hinges). For one embodiment, the display section 401A may include a transmissive display 405, and the display section 401B may include a reflective display 410. Each of the display sections 401A and 401B may include logic associated with the transmissive display 405 and the reflective display 410, respectively. There may be an interface used to drive two displays and to control the displaying of the information so that it can be displayed on one display at a time. For example, using dual channel LVDS (Low voltage differential signaling) where a first channel does odd and a second channel does even, the first channel may be dedicated to the first display, and the second channel may be dedicated to the second display. Other implementations to switch from the first display to the second display may also be used.

For one embodiment, the display section 401B may be folded to overlap with the display section 401A. For example, the display section 401B may be folded backward (shown by the directional arrow 402) to rest against the display section 401A such that both the reflective display 405 and the transmissive display 410 are visible, as illustrated in FIG. 4B.

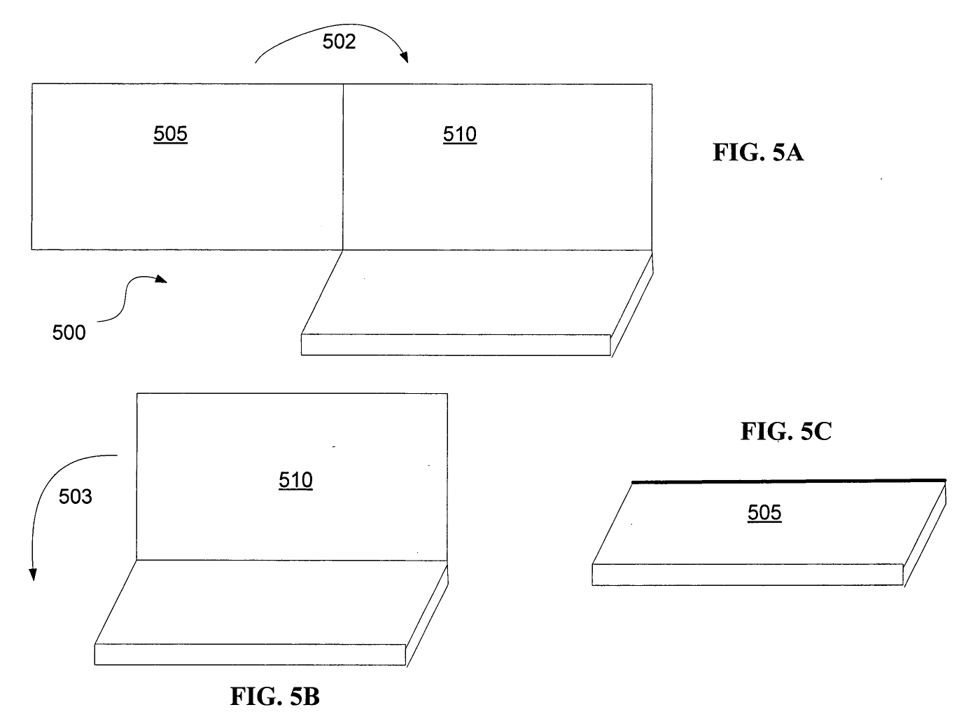

FIG. 5A illustrates another example of a computer system having dual displays, in accordance with one embodiment. For one embodiment, computer system 500 may include two displays. One may be a transmissive display 505 and the other may be a reflective display 510, each may be associated with a section of a display housing. The sections may be attached to one another using some types of attachment mechanism (e.g., hinges). There may be logic associated with the transmissive display 505 and the reflective display 510 in the corresponding display housing section. For example, as illustrated in an example in FIG. 5B, the transmissive display 505 and the reflective display 510 may be positioned side-by-side. For one embodiment, one display may be folded sideway (shown by the directional arrow 502) to overlap the other display, as illustrated in the example in FIG. 5B.

Having both a transmissive display and a reflective display may enable a user of a computer system to select a display based on lighting condition. The user may not need to move the computer system just so that the information displayed by the computer system can be more readable. For example, using the example illustrated in FIG. 2, the user may use the reflective display 210 when using the computer system 200 in a bright environment, and the user may use the transmissive display 205 when using the computer system 200 in a dark environment. When the computer system 200 is operating using a power source other than the normal alternating current (AC) power source, using the reflective display 210 also provides the added advantage of reducing the overall power consumption because it does not use a backlight. For example, typical displays consume approximately 3 Watts out of a total platform average power of approximately 11 Watts. Considering that a reflective display consumes only approximately 1 Watts, the overall power consumption associated with a display system may be reduced by approximately 20% by using the reflective display.

Bi-Stable Display

For one embodiment, to reduce power consumption associated with a display, one or both of the displays in a dual display computer system may be a bi-stable display. Generally, a bi-stable display may consume less power than a transmissive display because the bi-stable display is capable of retaining the information being displayed even when power to the bi-stable display has been turned off. In this situation, the bi-stable display may be referred to as being in a self-refresh state. The bi-stable display may only need power when the information being displayed is changed. Bi-stable display and its associated technology is known to one skilled in the art. A bi-stable display may be used when power usage is sensitive (e.g., to extend the battery life or to reduce power consumption).

Referring to the dual display system illustrated in FIG. 5A, one display may be a bi-stable display and the other display may be a transmissive display. The two displays may be folded (shown by the directional arrow 503) to be in the configuration illustrated in FIG. 5B. The two displays may further be folded to be in the configuration illustrated in FIG. 5C so that only one display is visible. In this configuration, the computer system 500 may be used as a tablet. For example, in the tablet configuration, the visible display may be a low power consumption display such as a bi-stable display instead of a transmissive display. Of course, when reducing power consumption is not an issue, the visible display in the tablet configuration may be a transmissive display. Although not shown, the displays of the computer system 400 illustrated in FIG. 4B may further be folded forward (shown by the directional arrow 403) to achieve the same tablet configuration as the computer system illustrated in FIG. 5C.

Usage Models

For one embodiment, the two displays in a dual display computer system may be used together to create a larger viewing area for a user to view displayed information, as illustrated in the examples in FIG. 4A and FIG. 5A. For one embodiment, the two displays may be used together such that both displays may display the same information. For example, as illustrated in FIG. 4B (or even in FIG. 4A and FIG. 5A), the same information may be viewed on the first display or on the second display. Two users may sit across from one another with a first user viewing the information on the first display, and a second user viewing the same information on the second display. There may be an interface that allows a display controller in a chipset (e.g., chipset 107 in FIG. 1) to control the transfer of the same information to both displays. Alternatively, different information may be displayed on each of the two displays. It may be noted that in these embodiments, both displays may be active at the same time.

For one embodiment, the same information may be displayed either on the first display or on the second display, but not at the same time. This may be referred to as a power savings setting where only one display may be active at a time. For example, a user may choose to view the information on a transmissive display when the computer system is positioned in a dark environment. The user may choose to view the same information on a reflective display when the computer system is positioned in a bright light environment. For one embodiment, power to the display not being used may be reduced. One advantage of this technique is the user may not need to move the computer system whenever the light condition changes. Another advantage of this technique is the power savings associated with not using the transmissive display while experiencing little disruption to viewing the information in a bright light environment. There may be an interface that allows the display controller to control the transfer of the same information to either the transmissive display or the reflective display. This interface may receive input from the user to determine which of the two displays to transfer the information. Alternatively, the input may be automatically generated by a sensor sensing the light condition. The sensor may part of the logic associated with the display system.

Process

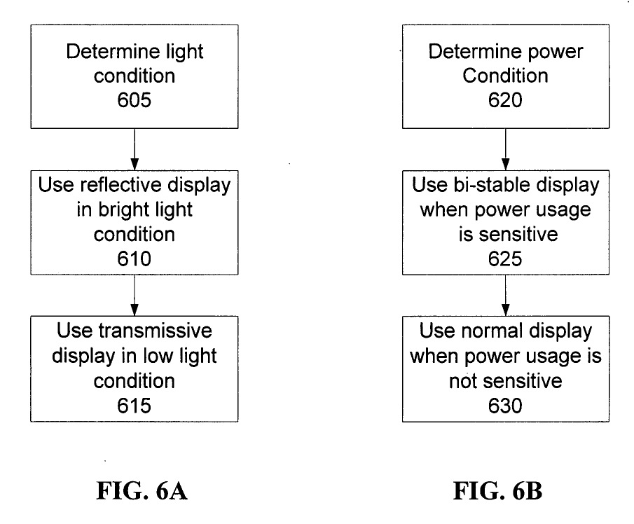

FIG. 6A is a block diagram illustrating an example of a process that may be used to reduce power consumption associated with a display system, in accordance with one embodiment. The process assumes that the display system includes two displays, a transmissive display and a reflective display. At block 605, the light condition is determined. This may be performed using a light sensor. When the sensor indicates that the environment is bright enough to enable information displayed on the reflective display to be readable, the reflective display is activated, as shown in block 610. The transmissive display may then be de-activated. When the sensor indicates that the environment is dark enough to prevent the information displayed on the reflective display to be readable, the transmissive display is activated, as shown in block 615. The reflective display may then be de-activated. Being de-activated may mean being placed in a mode that consumes zero or little power. Of course, a user may be notified that the switching of the displaying of the information is about to take place before a display is de-activated.

FIG. 6B is a block diagram illustrating another example of a process that may be used to reduce power consumption associated with a display system, in accordance with one embodiment. The process assumes that the display system includes two displays, a low power consumption display (e.g., bi-stable display) and a normal power consumption display (e.g., transmissive display). At block 620, the power condition is determined. This may be applicable when the power source is a direct current (DC) power source such as, for example, a battery. When the power condition is in a state that may need conservation, the bi-stable display may be activated, as shown in block 625. When the power condition is adequate (e.g., fully charged), the transmissive display may be used, as shown in block 630. The display that is not used may be de-activated.

Computer Readable Media

The operations of these various methods may be implemented by a processor in a computer system, which executes sequences of computer program instructions that are stored in a memory which may be considered to be a machine-readable storage media. The memory may be random access memory, read only memory, a persistent storage memory, such as mass storage device or any combination of these devices. Execution of the sequences of instruction may cause the processor to perform operations according to the process described in FIGS. 6A and 6B, for example.

The instructions may be loaded into memory of the computer system from a storage device or from one or more other computer systems (e.g. a server computer system) over a network connection. The instructions may be stored concurrently in several storage devices (e.g. DRAM and a hard disk, such as virtual memory). Consequently, the execution of these instructions may be performed directly by the processor. In other cases, the instructions may not be performed directly or they may not be directly executable by the processor. Under these circumstances, the executions may be executed by causing the processor to execute an interpreter that interprets the instructions, or by causing the processor to execute a compiler which converts the received instructions to instructions that which can be directly executed by the processor. In other embodiments, hard-wired circuitry may be used in place of or in combination with software instructions to implement the present invention. Thus, the present invention is not limited to any specific combination of hardware circuitry and software, nor to any particular source for the instructions executed by the computer system.

Although some embodiments of the present invention have been described with reference to specific exemplary embodiments, it will be evident that various modifications and changes may be made to these embodiments without departing from the broader spirit and scope of the invention as set forth in the claims. For example, although some embodiments have been described as being associated with a computer system, the color cylinder may also be used in various other applications (e.g., television systems, etc.). Accordingly, the specification and drawings are to be regarded in an illustrative rather than a restrictive sense.

What is claimed is:

1. A method, comprising:
displaying information from a computer system using a first display when the computer system is positioned in a first environment; and
displaying the information from the computer system using a second display when the computer system is positioned in a second environment, wherein the first display is capable of consuming more power than the second display, and wherein the first environment is not as bright as the second environment.

2. The method of claim 1, wherein the first display is a transmissive display.

3. The method of claim 2, wherein the second display is a reflective display.

4. The method of claim 1, wherein the information is displayed either on the first display or on the second display, but not at the same time.

5. A display apparatus, comprising:
a transmissive display to display information from a computer system when positioned in an environment with low light;
a reflective display coupled to the transmissive display to display the information when positioned in an environment with bright light; and
an interface coupled to both the transmissive display and the reflective display, wherein the interface is to control the displaying of the information on the transmissive display or on the reflective display.

6. The apparatus of claim 5, further comprising:
a light sensor coupled to the interface to sense light condition of an environment.

7. The apparatus of claim 6, wherein the transmissive display and the reflective display are positioned on each side of a display housing.

8. The apparatus of claim 6, wherein the transmissive display is positioned on a first display housing section, and wherein the reflective display is positioned on a second display housing section.

9. The apparatus of claim 8, wherein the first display housing is attached to the second display housing and is foldable relative to the second display housing.

10. An apparatus, comprising:
a low power consumption display associated with a first display section; and
a normal power consumption display coupled to the low power consumption display and associated with a second display section, wherein the first display section is attached to the second display section and is foldable relative to the second display housing.

11. The apparatus of claim 10, wherein the normal power consumption display is a transmissive display.

12. The apparatus of claim 11, wherein the low power consumption display is a reflective display.

13. The apparatus of claim 11, wherein the low power consumption display is a bi-stable display.

14. The apparatus of claim 10, wherein the first display section is configurable to fold and overlap the second display to enable only the low power consumption display or the normal power consumption display is visible.

15. The apparatus of claim 10, wherein the first display section is configurable to extend the second display to enable a large viewing area using both the low power consumption display and the normal power consumption display.

16. A system, comprising:
a processor; and
a display system coupled to the processor, the display system includes a low power consumption display and a normal power consumption display, wherein only the low power consumption display or the normal power consumption display is active at a time.

17. The system of claim 16, wherein the low power consumption display is a reflective display, and the normal power consumption display is a transmissive display.

18. The system of claim 16, wherein the low power consumption display is active in a bright light environment, and wherein the normal power consumption display is active in a low light environment.

19. The system of claim 18, further comprising an interface to control information being sent to the low power consumption display or to the normal power consumption display.

20. The system of claim 19, further comprising a sensor to determine when to activate the low power consumption display or the normal power consumption display.

21. The system of claim 20, wherein the power consumption of the normal power consumption display is reduced when the low power consumption display is active.
